(19) United States
(12) Patent Application Publication
(10) Pub. No.: US 2023/0214739 A1
(43) Pub. Date: Jul. 6, 2023

(54) RECOMMENDATION SYSTEM FOR IMPROVING SUPPORT FOR A SERVICE

(71) Applicant: Microsoft Technology Licensing, LLC, Redmond, WA (US)

(72) Inventors: Hrishikesh Devadatta KULKARNI, Seattle, WA (US); Navendu JAIN, Snohomish, WA (US)

(21) Appl. No.: 17/707,364

(22) Filed: Mar. 29, 2022

Related U.S. Application Data
(60) Provisional application No. 63/295,303, filed on Dec. 30, 2021.

(51) Int. Cl. G06Q 10/06

(52) U.S. Cl. CPC G06Q 10/063114; G06Q 10/06316; G06Q 10/06393

(57) ABSTRACT

The present disclosure relates to systems and methods that provide recommendations to service owners on what actions to take to modify a service of the service owners. The systems and methods analyze the service owner’s workload and telemetry from the services worked on by the service owners. The systems and methods provide recommendations with actions to take to modify the service based on a predicted outcome of the recommendations.

### CROSS-REFERENCE TO RELATED APPLICATIONS

This application claims priority to and the benefit of U.S. Provisional Pat. Application No. 63/295,303, filed on Dec. 30, 2021, which is hereby incorporated by reference in its entirety.

### BACKGROUND

To ensure high uptime of cloud services, on-call engineers are responsible for quickly and effectively resolving any service-impacting incidents (e.g., service down alerts). On-call engineers typically execute a wide range of tasks including alert triage, problem troubleshooting, impact analysis, diagnosis, and/or applying fixes required to mitigate the incident. Having a highly stressful on-call workload e.g., due to high volume or high complexity of service-impacting incidents that need to be handled, risks employee attrition and impacts service health metrics.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes identifying a recommendation with an action for modifying a service using telemetry of tasks performed by a service owner in resolving a plurality of events. Tasks include actions assigned to the service owner. The method includes generating a predicted outcome of the recommendation based on a predicted impact of the action on the plurality of events. The method includes providing the recommendation with the action and the predicted outcome.

Some implementations include a system. The system may include a processor; memory in electronic communication with the processor; and instructions stored in the memory, the instructions being executable by the processor to: identify a recommendation with an action for modifying a service using telemetry of tasks performed by a service owner in resolving a plurality of events; generate a predicted outcome of the recommendation based on a predicted impact of the action on the plurality of events; and provide the recommendation with the actions and the predicted outcome.

Some implementations include a method. The method includes obtaining telemetry of tasks performed by a service owner in resolving events included in a workload of the service owner. The method includes generating a taxonomy-based factor classification that provides a categorization of a plurality of contributing factors of the workloads. The method includes providing a recommendation for actions to take for modifying the service using the categorization of the plurality of contributing factors of the workload.

Some implementations include a method. The method includes obtaining telemetry of tasks performed by a service owner in resolving events included in a workload of the service owner. The method includes determining metrics for each contributing factor of a plurality of factors from the telemetry. The method includes generating a score for each contributing factor. The method includes determining a composite metric for the service owner by combining a weighted score for each contributing factor. The method includes identifying an action to take for modifying the service using the composite metric.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for providing recommendations in accordance with implementations of the present disclosure.

FIG. 2 illustrates an example taxonomy-based factor classification in accordance with implementations of the present disclosure.

FIG. 3 illustrates an example recommendation system in accordance with implementations of the present disclosure.

FIG. 4 illustrates an example GUI of a dashboard providing recommendations in accordance with implementations of the present disclosure.

FIG. 5 illustrates an example method for providing recommendations in accordance with implementations of the present disclosure.

FIG. 6 illustrates an example method for providing a taxonomy-based factor classification in accordance with implementations of the present disclosure.

FIG. 7 illustrates an example method for generating a composite metric for a plurality of contributing factors in accordance with implementations of the present disclosure.

### DETAILED DESCRIPTION

This disclosure generally relates to service owners (e.g., on-call engineers) supporting a service. This disclosure uses recommendations to improve reliability, availability, and/or efficiency of the service. To ensure high uptime of cloud services, service owners, such as on-call engineers, are responsible for quickly and effectively resolving service-impacting incidents (e.g., service down alerts). On-call includes an individual who is available to work at any time if needed. On-call service owners typically execute a wide range of tasks including alert triage, problem troubleshooting, impact analysis, diagnosis, and/or applying fixes required to mitigate the incident. Having a highly stressful on-call workload risks employee attrition and impacts service health metrics.

Given the variety of tasks done by such service owners, it is challenging to characterize service owners’ workload and drive improvements to the services and/or the workloads in a systematic manner. One challenge includes identifying the action(s) to take to address the pain points for service owners. Another challenge is quantifying the return-on-investment (ROI) of different actions for the on-call workload. Another challenge includes identifying the set of relevant actions to address the specific set of tasks for a given set of on-call service owners. Another challenge includes prioritizing actions by the ROI for the service and/or a given set of on-call service owners.

The systems and method of the present disclosure provide recommendations regarding areas to focus on and/or actions to take to improve the service in order to reduce alarms and/or incidents, which may be beneficial, e.g., for the on-call workload. In some implementations, the systems and methods provide a taxonomy-based factor classification to categorize the wide range of contributing factors impacting a service and on-call productivity in a systematic manner. In some implementations, the systems and methods provide a recommendation system that identifies specific actions (e.g., for a given set of on-call service owners) to take and quantifies the ROI for each of the identified actions.

The systems and methods analyze the workload, telemetry, and metadata from related services using one or more models (e.g., a machine learning model and/or models may be based on statistical analysis, natural language processing, or time series analysis). The systems and methods also analyze potential changes, risk to customer impact, and/or benefits to the service owner(s) and tunes the recommendations to optimize a ROI of the potential changes. In some implementations, the systems and methods are tuned to minimize customer impact versus to maximize benefit to service owner. After the change is made, the systems and methods continue to monitor and suggest additional changes to the engineering workload, on-call workload, and/or service.

One example use case includes the systems and methods providing a recommended action to change a monitor setting of the systems in response to the analysis of a historical workload and/or the telemetry information received from the historical workload (e.g., tasks performed by the on-call service owner in resolving the incidents in the workload, system parameters, and/or different contributing factors to the productivity of the on-call service owner). The recommendation indicates that if one of the monitor settings for an incident is changed from thirty minutes to fifty minutes, then the number of incidents would reduce by approximately twenty six notifications based on the past six months of incidents data. As such, the recommendation provides an action to take (e.g., changing a monitor setting) to reduce incidents (e.g., reduce ‘noise’ notifications) and indicates what kind of estimated impact the change would have on the on-call service owner’s workload (e.g., it would have prevented about twenty six notifications).

One technical advantage of the systems and methods of the present disclosure is increased reliability and availability of the service. Another technical advantage of the systems and methods of the present disclosure is improvement to on-call service owner productivity, resulting in expedited resolution of customer impacting incidents (e.g., lower time to respond to incidents, lower time to resolve customer issues). The improvements to the on-call service owner productivity also result in improved happiness or lower stress of the on-call service owners.

As such, the systems and methods of the present disclosure provide recommendations to service owners on what actions to take to reduce the service owners’ workload by analyzing the historical workload, telemetry, and/or related metadata from services worked on by the on-call service owners. To understand the impact and benefit of each recommendation, the systems and methods support displaying the analysis via a dashboard (e.g., for on-call service owners). Service owners are able to easily review and understand the suggestion to improve service performance (e.g., availability and reliability), as well as reducing the service owners’ workload and improving their work-life balance.

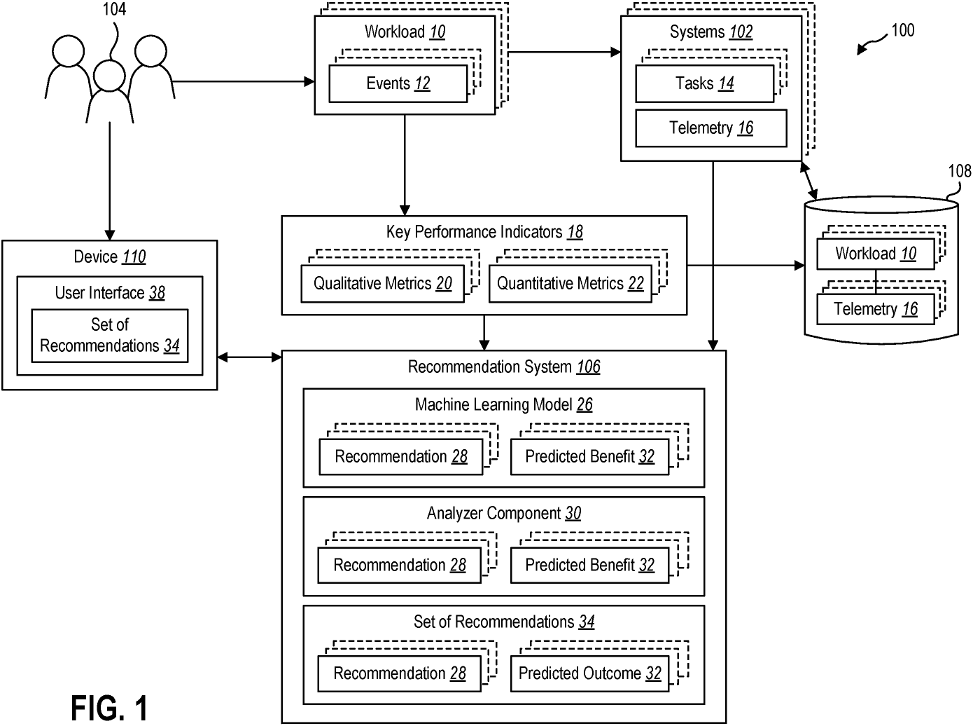

Referring now to FIG. 1, illustrated is an example environment 100 for providing recommendations for improving service performance and the workloads 10 of service owners (e.g., on-call service owners 104). A service also refers to a software functionality or a set of software functionalities (such as the retrieval of specified information or the execution of a set of operations) with a purpose that different clients can reuse for different purposes, together with the policies that should control its usage (based on the identity of the client requesting the service, for example). A service includes a mechanism to enable access to one or more capabilities, where the access is provided using a prescribed interface and is exercised consistent with constraints and policies as specified by the service description.

The workloads 10 are related to an amount of time and computing resources required to perform a specific task or produce an output from the inputs provided to resolve the events 12 included in the workloads 10. Resolving the events 12 may include mitigating the events 12. Service owners are entities who are accountable for all aspects including design, implementation, testing, deployment, and operations of a service. Service owners include individuals working on a service. Service owners may be human or bots. Examples of service owners 104 include on-call engineers, system administrators, developers of the service, or operators of the service. The workload 10 includes one or more events 12 related to the systems 102 of the environment 100. In some implementations, the systems 102 include services of a cloud-computing system (e.g., a cloud-computing platform). Events 12 include anything that happens related to the systems 102. Events 12 include any problem or alert that may need to be resolved for the systems 102. Problems include any unwelcome event 12 or harmful event 12 that needs to be dealt with or overcome. For example, a problem includes an event 12 where the service is unresponsive to the user. Another example of a problem includes an event 12 where the service is unavailable to the user. Another example of a problem includes an event 12 where the service is operating incorrectly. An alert includes a notification of a problem or a potential problem. An example of an alert is an indication that the service is becoming unstable or unreliable. Another example of an alert is a notification that the service is unavailable. In some implementations, the events 12 include changes to the systems 102, such as, new code development, which may be useful to understand the alerts (e.g., a new code deployed to a region where a service starts failing right after deployment is happening). In some implementations, the events 12 are transient issues which auto resolve. In some implementations, the events 12 include incidents that are unanticipated or unplanned interruption of the systems 102 or service and/or a reduction in quality of the systems 102 or service. In some implementations, the events 12 are customer impacting (e.g., the service provided by the system 102 is down or the system 102 is working improperly, and thus, impacting the customer’s experience with the system 102). The events 12 can also be created by users of the systems 102 reporting problems or issues (e.g., a customer calling the service owner 104 reporting the issues or a system administrator reporting the issues). The events 12 are described by a cluster of data elements that include information about when the events 12 happened, where the events 12 happened, what assistance was received for the events 12, how much assistance was received for the events 12, and from whom (e.g., a service owner 104) the assistance was received.

The service owners 104 perform tasks 14 on the systems 102 to resolve the events 12 the events 12. Tasks 14 are a set of either independent or related work items to be executed towards a specified goal. Tasks 14 include identifying a cause of the event 12, alert triage, impact analysis, problem troubleshooting, diagnosis, applying fixes, and/or any action required to resolve or fix the event 12. In some implementations, different tasks 14 are selected for different events 12 and/or selected based on a complexity or severity of the events 12. As such, the service owners 104 perform a variety of tasks 14 for each event 12 included in the workloads 10.

In some implementations, the events 12 are automatically detected by monitoring applications of the systems 102. For example, the monitoring applications monitor a performance of the systems 102 and compare the performance to a metric. If the performance of the system is below the metric (e.g., the system is not performing properly), the monitoring application(s) automatically trigger a creation of the event 12. One example includes the monitoring application automatically creating the event 12 for a failure of the control plane of the system 102 in response to the monitoring application detecting an error in the performance of the control plane. The events 12 included in the workload 10 of the service owners 104 are provided from a variety of sources (e.g., users of the systems or applications of the systems).

While working on the events 12, the service owners 104 interact with different systems 102 executing a variety of tasks 14 to resolve the events 12 the events 12. The systems 102 provide telemetry 16 for the service. The systems 102 also provide telemetry 16 for the different tasks 14 performed by the service owners 104. The telemetry 16 is a collection of measurements and/or data points at different points and the communication and/or transmission of the measurements and/or data points to a set of receivers for monitoring scenarios. The telemetry 16 includes the information provided by the systems 102. The telemetry 16 also includes information provided by the service owners 104. The telemetry 16 includes, for example, the number of events 12 received for the system 102, a time of day the events 12 occurred, actions performed by the service owners 104, different system configurations, and/or metadata for actions performed by the service owners 104 (e.g., change a level of urgency of the events 12, transferred the event 12 to another service owner 104).

One or more key performance indicators (KPI) 18 are generated for the events 12. The KPI 18 provide metrics that measure the service owners’ 104 workloads 10 and performance in performing the tasks 14 to resolve the events 12 included in the workloads 10. The KPI 18 are generated based on an aggregation of the events 12.

In some implementations, the KPI 18 are qualitative metrics 20 generated in response to feedback received from the service owners 104. KPI provide a framework for defining server-side calculations that measure the events 12 and may standardize how the resulting information is displayed. KPI may be metadata wrappers around regular measures and other Multidimensional Expressions (MDX) expressions. The qualitative metrics 20 provide subjective assessments of the experiences of the service owners 104 or users of the service. Examples of the qualitative metrics 20 include survey results or interview results where the service owners 104 rate an experience or describes in their own words an experience.

In some implementations, the KPI 18 are quantitative metrics 22 generated using the telemetry 16 of the systems 102. Examples of quantitative metrics 22 include a number of events 12 received, an amount of time spent on a call performing tasks 14 to resolve a particular event 12, a total amount of time spent resolving the event 12, and/or a time of day when the event 12 occurred (e.g., late at night, during business hours). In some implementations, the KPI 18 includes a combination of both qualitative metrics 20 and quantitative metrics 22. As such, the KPI 18 identify contributing factors or metrics of a health of the service and/or identify contributing factors to the workload 10 of the service owners 104.

The KPI 18 also identify factors that impact a productivity of the service owner 104 and/or the workload 10 of the service owners 104. One example of impacting a productivity of the service owners 104 includes increasing a response time for responding to the events in the workload. Another example of impacting a productivity of the service owners 104 includes increasing an amount of time to resolve the events in the workload. The KPI 18 can help identify factors that impact the service reliability, availability of the service, etc.

In some implementations, a summary status is generated for the KPI 18 to provide a measure of the workload 10 of the service owners 104. In some implementations, the summary status is generated for the KPI 18 to provide a measure of the service. The summary status is a high-level indicator, either quantitative or qualitative, that provides a summary view of one or more factors of features associated with the underlying scenario (e.g., a workload for an on-call engineer). The summary status is measured on a scale. One example of the summary status is an index function. Another example of the summary status is a composite metric. For example, the summary status indicates whether the service is operating correctly or whether the service is having problems (e.g., portions of the service are exceeding a threshold level or under a threshold level). For example, the summary status indicates whether the service owner 104 is overloaded with the workload 10 (e.g., the workload 10 includes a number of events 12 that exceeds a threshold level). Another example includes the summary status indicating a workflow of the service owner 104 (e.g., the workload 10 includes a number of events 12 that have remained in the workload 10 past a time frame). For example, five events 12 remained in the workload 10 past two days. In some implementations, the summary status identifies key factors that impact a productivity of the service owner 104 and/or the workload 10 of the service owners 104.

One or more datastores 108 store the telemetry 16 of the systems 102 and the KPI 18 of the tasks 14 performed by the service owners 104 for resolving the events 12 included in the workloads 10. As such, the datastores 108 include the historical workload information obtained from the telemetry 16 and the KPI 18 of the different workloads 10 of the service owners 104.

A recommendation system 106 receives the workloads 10 of the service owners 104, the telemetry 16, and/or metadata from related tasks 14 performed by the service owners 104. In some implementations, the recommendation system 106 receives the workloads 10, the telemetry 16, and/or metadata from the datastores 108. In some implementations, the recommendation system 106 receives the workloads 10, the telemetry 16, and/or metadata from the systems 102.

The recommendation system 106 includes one or more models (e.g., machine learning models 26 and/or models based on statistical analysis, natural language processing, or time series analysis) that analyzes the workloads 10 of the service owners 104, the telemetry 16, and the KPI 18. Examples of the machine learning models 26 include supervised classification models, unsupervised models for auto correlation, time series forecasting models, natural language processing for entity recognition and intent extraction, etc. The machine learning models 26 identify different recommendations 28 with one or more actions to take for modifying the systems 102, the service, and/or the workloads 10 of the service owners 104. Actions denote a process of doing something, typically to achieve an aim (e.g., change). In some implementations, the one or more actions are tactical actions that handle live events or incidents of the systems 102. In some implementations, the one or more actions are strategic actions that make changes (e.g., offline changes) to the systems 102 and/or the workloads 10.

In some implementations, the machine learning model 26 generates a predicted outcome 32 of the recommendations 28 based on a predicted impact of the action on the event(s) 12. The predicted impact of the action includes different outcomes of the actions on the event(s) 12. The predicted impact includes results of applying the action to the event(s) 12 (e.g., benefits of applying the action to the event(s) 12 or disadvantages of applying the action to the event(s) 12). In some implementations, the machine learning model 26 predicts different outcomes if the one or more actions were applied retrospectively to the workloads 10, e.g., by determining the estimated impact of the one or more actions on the historical events corresponding to the workload. A simulation is the imitation of the operation of a real-world process or system over time using models that represents the key characteristics or behaviors of the selected system or process. The simulation represents the evolution of the model over time. In some implementations, the machine learning model 26 performs emulations of the recommendations 28 and predicting different outcomes if the one or more actions were applied to the workloads 10. In some implementations, the machine learning model 26 performs synthetic and/or artificial setups (e.g., feeding crafted input to a deployed system) of the one or more actions applied to the workloads 10 and predicting different outcomes of the recommendations 28. For example, the machine learning model 26 performs disaster recovery drills for the synthetic and/or artificial setups of the recommendations 28.

The actions include changes to the systems 102, changes to tasks 14 performed by the service owners 104 for resolving the events 12, and/or changes of an order of performing tasks 14 for resolving the events 12. The predicted outcomes include improving the service, the systems 102, and/or the workloads 10 of the service owners 104. The predicted outcomes also include improvements to the service itself (e.g., reliability, availability) One example of improving the workload 10 includes reducing a number of events 12 in the workloads 10. Another example of improvements includes reducing the time to detect of events 12 in the workloads 10. Yet another example of improvements includes the lift in confidence or accuracy of declaring a service impacting outage based on the events.

In embodiments, during the simulation of the different recommendations 28 on the workloads 10, the machine learning models 26 estimate a series of KPI for the simulated recommendations 28. The estimated KPI provide an approximation of different factors impacting a productivity of the service owner 104 if the actions were applied to the workloads 10. The estimated KPI are used to generate a predicted outcome to the workloads 10.

In an implementation, the estimated KPI are used to determine a predicted outcome for the recommendations 28. In some implementations, the predicted outcome 32 is a single score based on an aggregation of the estimated KPI . For example, a composite score is generated for the KPI and used for the predicted outcome 32.

In some implementations, the predicted outcome 32 is determined in response to a context of the service owner 104. For example, the context identifies a webpage that the service owner 104 is visiting for guidance in reducing a number of events 12 and the predicted outcome 32 is selected to highlight a reduction in events for the recommendation 28. Another example includes a specific KPI is selected based on a business impact of the service owner 104 and the predicted outcome 32 reflects an improvement for the KPI for the recommendation 28. For example, a timing KPI is selected for the service owner 104 and the predicted outcome 32 reflects improvements in receiving events 12 outside of business hours.

As such, the machine learning model 26 generates a plurality of recommendations 28 and predicted outcomes (e.g., the predicted outcomes 32) for the different recommendations 28. Each recommendation 28 generated by the machine learning model 26 includes a corresponding predicted outcome 32. The predicted outcome 32 provides an indication of a corresponding impact to the service and/or workload 10 of the service owner 104 if the recommendation 28 was implemented.

One example use case includes the machine learning model 26 identifying a monitoring setting on the system 102 that provided duplicative event 12 alerts during a monitoring cycle of 120 minutes in response to analyzing the telemetry 16 information and the workloads 10 and KPI 18 of the service owners 104. The machine learning model 26 provides a recommendation 28 to change the monitoring setting on the system 102 from a previous value of 120 minutes to a new value of 240 minutes. The machine learning model 26 also generates a predicted outcome 32 for the recommendation 28 in response to simulating the different KPI for the actions included in recommendation 28. For example, the predicted outcome 32 indicates a reduction of 23 events 12 if the recommendation 28 is implemented on the system 102. As such, the predicted outcome 32 indicates a predicted outcome of a reduction of 23 events 12 will occur for each monitoring cycle of the monitoring setting if the service owner 104 implements the recommendation 28 and changes the monitoring setting of the system 102 from 120 minutes to 240 minutes.

The machine learning models 26 analyze the data for the service owners 104 workloads 10 and performs different analysis on the data to predict the expected results of making changes to the systems 102 and/or the tasks 14 performed for resolving the events 12. The expected results are used in formulating one or more recommendations 28 with a predicted outcome for improving the workloads 10 of the service owners 104.

The recommendation system 106 also includes an analyzer component 30 that analyzes the predicted outcomes 32 of each recommendation 28 in relation to a risk of implementing the recommendation 28 and/or a cost of implementing the recommendation 28 and determines a rank for the recommendation 28 in response to a cost versus risk versus benefit analysis for each recommendation 28. A risk is a situation involving exposure to unexpected and/or unintended behavior or situation with respect to a service. The cost is the amount of services (e.g., computing, human, network, monetary) paid towards an objective. The benefit includes useful results to the service or advantages to the service. In an implementation, a set of recommendations 34 is created with a ranked list of the recommendations 28. The recommendations 28 are placed in an order based on the cost-benefit analysis performed on the different recommendations 28. One example is to measure cost versus benefit analysis of implementing the recommendation 28 is to quantify the engineering team’s time and effort in implementing, testing, staging, releasing, and deploying the change to the service. Another example of the cost versus benefit analysis is the number of dependency services which will be impacted due to a change and who in turn may have to make further changes in handle the primary change.

In some implementations, the recommendations 28 that include a high risk are placed lower in the order relative to the recommendations 28 with a lower risk. An example recommendation 28 that is high risk includes changing a setting on the system 102 that would result in an important event 12 possibly going undetected. An example of a lower risk change is one that can be quickly rolled back e.g., a change to a configuration file and not to the service code, which may require a relatively longer cycle of development, building, testing, and deployment.

In some implementations, the recommendations 28 that include a high benefit are placed higher in the ranking order relative to other recommendations 28 with a lower benefit. An example of a benefit is a reduction in the workload 10. For example, recommendations 28 that reduce the workload 10 by a larger number of events 12 have a high benefit relative to recommendations 28 that reduce the workload 10 by a lower number of events 12. An example of a high benefit is a large reduction in the workload 10 (e.g., the recommendation 28 reduces the workload 10 by two hundred events 12) and an example of a low benefit is a minimal reduction in the workload 10 (e.g., the recommendation 28 reduces the workload 10 by two events 12). In some implementations, a combination of the costs, risks, and benefits is used to determine an order for the placement of the recommendations 28. For example, recommendations 28 with a high benefit, low cost, and a low risk are placed higher in the order relative to recommendations 28 with a high benefit, high cost, and a high risk. As such, the analyzer component 30 balances the risks, costs, and/or benefits for the different recommendations 28 in determining a ranking for the recommendations 28 in the set of recommendations 28.

As such, the recommendation system 106 analyzes the suggested action provided in the recommendations 28, risk to customer impact, predicted costs, and/or the predicted outcomes to the on call service owner 104 and tunes the recommendations 28 to optimize a predicted outcome 32 of the potential changes. In some implementations, the predicted outcomes 32 are tuned to minimize customer impact versus maximizing benefit to the service owner 104. For example, the predicted outcome has an estimated return on investment (ROI) that provides a tuple of information for the recommendation 28 including the predicted outcome, a cost of the recommendation, and a risk of the recommendation. The ROI is a ratio of the net benefit in terms of service health metrics to investment in terms of efforts needed to make the change and risk that the change will negatively impact the service. As such, the ROI provides a measure of the predicted outcome in combination with the cost and/or risk of implementing the recommendation 28 in an easy to understand manner.

The set of recommendations 28 are presented to the service owners 104 of the environment 100 as different actions or changes to implement to improve the service and/or the workloads 10 of the service owners 104. The set of recommendations 28 also provide the estimated benefit (e.g., reduction in noisy alerts, reductions in events, improvement in on-call scheduling) of the recommendations 28. In some implementations, the recommendations 28 include actions to change to the systems 102. In some implementations, the recommendations 28 are changes in the tasks 14 selected for resolving the events 12.

In some implementations, the set of recommendations 34 are sent to the service owners 104 through an e-mail message. The e-mail message includes the summary status for the workload 10 of the service owner 104. In an implementation, the summary status provides an indication of the overall workload 10 of the service owner 104. The e-mail message also includes the set of recommendations 34 for improving the summary status and/or the workload 10. In addition, in some implementations, the e-mail message includes information regarding trends and/or factors impacting the workloads 10. The e-mail message may also include a comparison of the summary status for the service owners 104 workload 10 compared to a summary status of peers of the service owners 104 (e.g., service owners 104 working on the same service). As such, the e-mail message is personalized for each service owner 104 with the set of recommendations 34 and/or additional information selected for the service owner 104.

In some implementations, the set of recommendations 34 are presented to users, e.g., service owners 104, on a user interface 38 on a display of a device 110. One example includes the set of recommendations 34 presented in a ranked list based on the predicted outcomes 32. Another example includes the set of recommendations 34 is presented in a descending order of ROI for the predicted outcomes. The user interface 38 visually displays the cost versus risk versus benefit analysis of the set of recommendations 34 so that the service owners 104 easily understand the information presented. The service owners 104 use the user interface 38 to review, understand, and evaluate the suggestions provided in the set of recommendations 34 and/or the corresponding estimated risks, costs, and/or benefits of the different recommendations 28 included in the set of recommendations 34.

The set of recommendations 34 provide insights into pain points or problematic areas of the workloads 10 for the service owners 104. The recommendations 34 are used to provide recommended actions to improve the workloads 10 (e.g., reduce the number of events 12 included in the workloads 10) of the service owners 104. In some implementations, the service owners 104 access the user interface 38 through a dashboard or webpage using the device 110. In some implementations, the user interface 38 is an interactive query interface.

In some implementations, the recommendation system 106 automatically implements a subset of the recommendations 28 included in the set of recommendations 34. For example, if the predicted outcome 32 of the recommendation 28 exceeds a threshold level (e.g., the estimated benefit of the predicted outcome 32 is above a threshold level), the recommendation system 106 automatically implements the action included in the recommendation 28. One example where the recommendation system 106 automatically implements the action included in the recommendation 28 is to change the auto-mitigation setting in the monitor to reduce noisy notifications and incidents. Another example is to automatically set the value of the creation window to correlate alerts in the settings of correlation rules.

In some implementations, the environment 100 has multiple models (e.g., machine learning models 26 and/or models based on statistical analysis, natural language processing, or time series analysis) running simultaneously. In some implementations, one or more computing devices are used to perform the processing of environment 100. The one or more computing devices may include server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the recommendation system 106, the user interface 38, and/or the datastores 108 are implemented wholly on the same computing device. Another example includes one or more subcomponents of the recommendation system 106, the systems 102, the user interface 38, and/or the datastores 108 implemented across multiple computing devices. Moreover, in some implementations, the recommendation system 106, the systems 102, the user interface 38, and/or the datastores 108 are implemented or processed on different server devices of the same or different cloud computing networks. Moreover, in some implementations, the features and functionalities are implemented or processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

As such, the environment 100 may be used to identify pain points or problematic areas of the services and/or the workloads 10 for the service owners 104 and drive overall improvements to the service. A set of recommendations 34 are provided with different actions to improve the service or the service performance of the services or the systems 102 supported by the service owner 104. One example of improved service performance includes the service owners 104 has more availability for resolving events 12. Another example of improved service performance includes the service owners 104 addressing the events 12 in a timely manner. Improving the service results in improvements to the workloads 10 of the service owners 104, such as, reducing a number of events 12 included in the workloads 10 and/or increasing the availability of the service owners 104. Improvements to the service and/or the workloads 10 of the service owners 104 results in improvements in the workload balance for the service owners 104. Moreover, a work-life balance of the service owners 104 improves by reducing the service owners 104 workload. After the recommended changes are made, the recommendation system 106 continues to monitor and suggest additional changes to the service or the systems 102.

The environment 100 may be used to identify pain points or problematic areas of the systems 102. A set of recommendations 34 are provided with different actions to improve the systems 102.

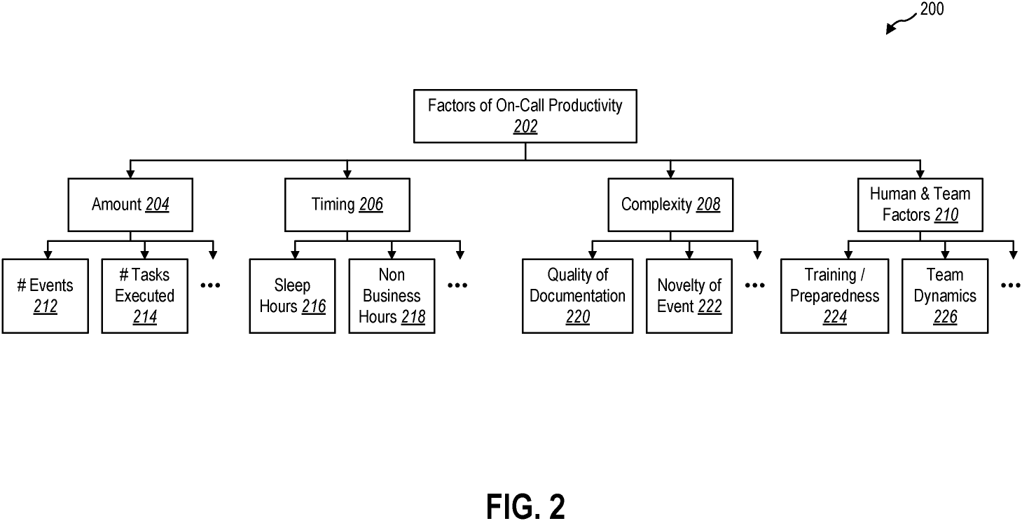

Referring now to FIG. 2, illustrated is an example taxonomy-based factor classification 200 of KPI 18 (FIG. 1) that impact a service and/or a productivity of the service owner 104. The taxonomy-based factor classification 200 categorizes the wide range of contributing factors 202 (e.g., the KPI 18) impacting the service and/or on-call productivity in a structured manner. In some implementations, the structured manner is a hierarchy of categories and sub-categories of the contributing factors 202 impacting the service and/or on-call productivity. A first level of the hierarchy includes the categories of the contributing factors 202. Example categories include an amount category 204, a timing category 206, a complexity category 208, and a human and team factors category 210.

Each category is divided into subcategories and the second level of the hierarchy includes the subcategories. For example, the amount category 204 includes a number of events subcategory 212 and a number of tasks executed subcategory 214. The timing category 206 includes a sleep hours subcategory 216 and non-business hours subcategory 218. The complexity category 208 includes a quality of documentation subcategory 220 and a novelty of event subcategory 222. The human and team factors category 210 includes a training and preparedness subcategory 224 and a team dynamic subcategory 226. In some implementations, the taxonomy-based factor classification 200 is hierarchical across space and time (e.g., the amount or volume is further divided based on the criticality of the amount).

In some implementations, the taxonomy-based factors classification 200 is generated using an aggregation of telemetry 16 received for the different tasks 14 (FIG. 1) performed by a plurality of service owners (e.g., service owners 104) in resolving the events 12 (FIG. 1) included in their workloads 10 (FIG. 1). For example, the telemetry 16 information and/or the associated KPI 18 for different service owners 104 is obtained from one or more datastores 108 (FIG. 1). In some implementations, the recommendation system 106 generates the taxonomy-based classification 200 using the obtained telemetry 16 information and/or the KPI 18. In some implementations, the taxonomy-based classification 200 is generated based on domain knowledge and data-driven measurements. The taxonomy then helps determine the recommendations (e.g., one action to correspond one to one for reduction of the individual factors (leaves) in the taxonomy tree).

In some implementations, the taxonomy-based factors classification 200 is used to create a summary status, such as, a composite metric that the recommendation system 106 (FIG. 1) uses to evaluate the predicted outcome 32 (FIG. 1) of taking a particular action suggested in a recommendation 28 (FIG. 1). The composite metric condenses the taxonomy-based factor classification 200 into a quantitative measure. The composite metric is an aggregate of the different categories (e.g., the amount category 204, the timing category 206, the complexity category 208, human and team factors category 210) and subcategories (e.g., a number of events subcategory 212, a number of tasks executed subcategory 214, a sleep hours subcategory 216, a non-business hours subcategory 218, a quality of documentation subcategory 220, a training and preparedness subcategory 224, a novelty of event subcategory 222, and a team dynamic subcategory 226) that impact the workloads 10 of the service owners 104.

Having different contributing factors 202 (e.g., different KPI 18) that impact the service and/or the workloads 10 of the service owners 104 makes it difficult for the service owners 104 to determine which recommendations 28 to take because experiences vary over different factors, number of events, amount of time it takes to resolve the event, complexity of the event, and/or the timing (e.g., fixing the event during night time hours or other non-business hours (weekends), or during business hours). The composite metric aggregates all of the different contributing factors 202 into a single score that is used to provide a standard metric for different evaluations of the recommendations 28 (e.g., evaluating the predicted outcome 32 for the different recommendations 28). The composite metric provides a single measure of an intensity of the on-call experience is at a given point in time.

In some implementations, the composite metric is based on a subset of the contributing factors 202 that impact a volume of work, impact the time when the work occurs, impact a complexity of the work, and/or impact the teams involved or knowledge required to solve the events 12. The subset of the contributing factors 202 include notifications, event effort, time on bridge (e.g., collaborating with other individuals), and rotation length. The telemetry 16 from the different platforms that the service owner 104 used in resolving the events 12 in the service owner’s 104 workload 10 is received and used to calculate the composite metric. In some implementations, the telemetry 16 is received from the service owners 104.

The notifications include interruptions related to the events 12 received by the service owners 104. The notifications include varying weights depending on timing of the notifications (e.g., business hours (8 am to 6 pm), non-business hours (weekends, 6 pm to 11 pm), or during sleep hours (11 pm to 6 am) and/or a source of the notifications (e.g., a customer, an automatic alert from the system). Example notifications include phone calls, SMS messages, e-mail messages, and/or application pushed messages received by the service owner 104 with information related to the events 12. The impact of the notifications may vary by the time of day. As such, the notifications are weighted according to the time segments. For example, notifications received during business hours have a lower weight (e.g., a weight of 1) as compared to notifications received during non-business hours (e.g., a weight of 2) and notifications received during sleep hours have a higher weight (e.g., a weight of 3) as compared to notifications received during non-business hours or daytime hours. The weights may be derived based on feedback received from the service owners 104.

The event effort is calculated from the total number of events 12 where the service owner 104 is listed. The event effort indicates an intensity of the events 12 and an amount of effort spent by the service owner 104 in troubleshooting the events 12. The event effort indicates how complex an event 12 was to investigate and/or resolve. For example, the events 12 with customer impact (e.g., the service is down or unavailable or the service is operating improperly) have a lower intensity score as compared to the events 12 without customer impact (e.g., the events 12 without an impact to the service). Another example includes the events 12 that require the service owner 104 to take an action to resolve the events 12 have a lower intensity score as compared to the events 12 that automatically resolve (e.g., the service owner 104 does not need to take action to resolve the events 12) with a higher intensity score. As such, the events 12 that are automatically resolved by systems are easier to investigate and/or resolve for the service owners 104 as compared to the events 12 where the service owners 104 investigate and/or troubleshoot the events 12. The event effort may be based on the intensity score and used to provide insights into the complexity of the event 12. The event effort may provide different ways of assessing the complexity of the event 12.

A bridge provides connections for collaboration with other individuals. The time on a bridge is calculated from the total time spent by the service owner 104 in communicating with other individuals (e.g., collaborating with team members, sending out customer communications, communicating with leadership, sharing discussing notes, and/or any other form of collaboration) in minutes. The rotation length is a total normalized on-call duration in hours for the service owner 104.

Each of the raw values of the different subsets of factors is measured and evaluated from the telemetry 16. For example, for on-call duration, the raw value is the sum of the total hours scheduled on rotation. The raw values are rescaled to avoid skewing to ensure that each subfactor is weighted independently and the weights are as expected. The rescaling standardizes each metric to arrive at a score for each contributing factor. The weights for the contributing factors may change based on feedback received from the service owners 104. In addition, the weights indicate a complexity of the events 12 and may change based on the complexity of the events 12. A raw score is derived by multiplying the each of the contributing factor values against its weight. An example equation for calculating the raw score for the composite metric is:

$$\begin{matrix}\text{Composite} \text{Metric} \text{=} \left({w}_{1} \times {x}_{1}\right) + \left({w}_{2} \times {x}_{2}\right) + \left({w}_{3} \times {x}_{3}\right) + … + \\ \left({w}_{n} \times {x}_{n}\right)\end{matrix}$$

where “w” is the weighting factor, and “x” is a contributing factor. Another example equation for calculating the raw score for the composite metric is:

$$\text{Composite} \text{Metric} \text{=} \frac{1}{\left(1 + {e}^{- \left(\left({w}_{1} \times {x}_{1}\right) + \left({w}_{2} \times {x}_{2}\right) + \left({w}_{3} \times {x}_{3}\right) + … + \left({w}_{n} \times {x}_{n}\right)\right)}\right)}$$

where “w” is the weighting factor, and “x” is a contributing factor.

The raw score for the composite metric is compared against a benchmark sample of a baseline group and transformed into a percentage, where a higher percentage reflects a better score relative to a lower percentage. For example, a composite metric in the 90^{th} percentile of the baseline group leads to a composite metric of 90%. The final percentage is provided as the composite metric and is used to identify a relative ranking for each service owner 104. By comparing the composite metric relative to the baseline population, context is provided to the composite metric (e.g., the composite metric is lower than the baseline population and is an unhealthy score where an intervention may be needed, or the composite metric is higher than the baseline population and is a healthy score). In addition, the composite metric may be aggregated for teams and/or organizations and used to identify a ranking for teams of service owners 104 (e.g., a team of service owners 104 supporting a service). As such, the composite metric produces a curve relative to the baseline group where new experiences may be mapped to the curve.

In some implementations, the composite metric is used as a standard metric to compare the quality of service of the workloads 10 across an organization. In some implementations, the composite metric is used as a standard metric to compare the workloads 10 among service owners 104 supporting the same systems 102 (FIG. 1), service, and/or product. In some implementations, the composite metric is used to track on an individual basis the workloads 10 of the service owners 104 and/or an individual wellbeing of the service owners 104. As such, the composite metric is used to measure the wellbeing of the service owners 104 and/or the workloads 10 of the service owners 104.

In some implementations, the composite metric is used to identify areas for improvement of the service. The composite metric is used to prioritize the events 12. In some implementations, the composite metric is used to focus resources to improve the health of the service and/or improve service stability. In some implementations, the composite metric is used as a standard metric across an organization to track the different services and used to compare the different services of the organization.

The categorization provided by the taxonomy-based factor classification 200 provides a mechanism to identify the different contributing factors 202 of on-call productivity by measuring the workloads 10 of the service owners 104 and enables new tasks 14 (FIG. 1) to be easily mapped to a global taxonomy view.

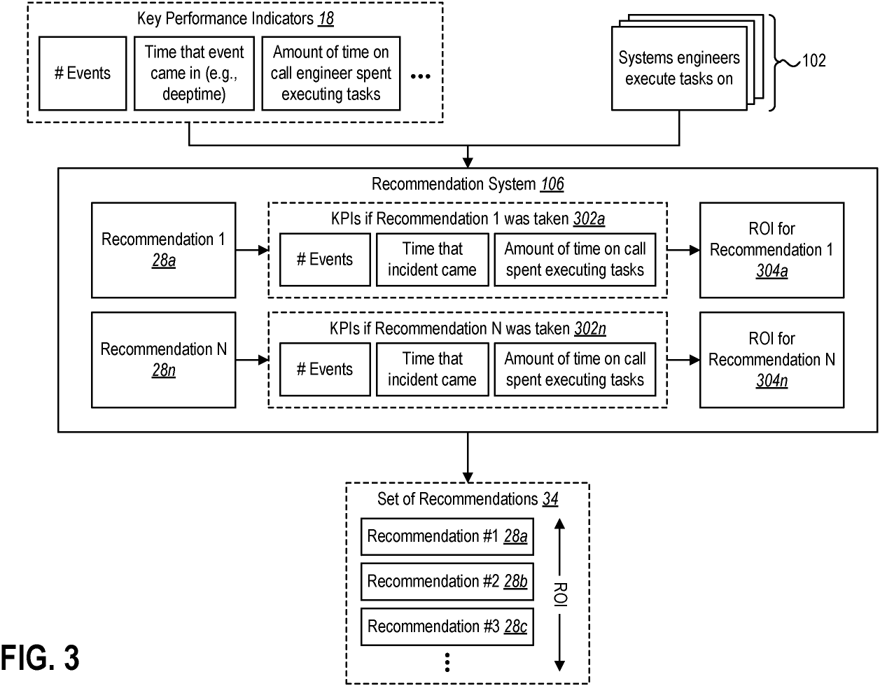

Referring now to FIG. 3, illustrated is the recommendation system 106 for use with the environment 100 (FIG. 1) in accordance with some implementations. The recommendation system 106 identifies specific actions for a given set of service owners 104 (FIG. 1) and provides an estimated benefit (e.g., the predicted outcome 32 (FIG. 1)) for each of the identified actions.

The recommendation system 106 receives the telemetry 16 (FIG. 1) from the tasks 14 (FIG. 1) executed by the service owners 104 and the KPI 18 (FIG. 1) of the service owners 104 workloads 10 (FIG. 1). In some implementations, the recommendation system 106 receives the telemetry 16 and the KPI 18 from the datastores 108. For each action identified by the recommendation system 106 included in the recommendations 28, KPI 302 are estimated for the different actions up to n actions (where n is a positive integer). The estimated KPI 302a to 302n provide an estimation if the action included in the recommendation 28 had been applied to the events 12 included in the workloads 10. In some implementations, the events 12 include incidents included in the workloads 10 of the service owners 104. In some implementations, the models (e.g., machine learning models 26) simulate the different actions included in the recommendations 28 by applying the different actions to the events 12 in the workloads 10. Any number of different actions are simulated by the machine learning models 26. Examples of the estimated KPI 302 include a number of events included in the workloads 10, a time the event 12 occurred, and/or an amount of time spent performing tasks resolving the events.

In some implementations, the estimated KPI 302 change in response to a context of the service owner 104. For example, the KPI 302 are selected in response to a user profile of the service owner 104 (e.g., a service that the service owner 104 supports). Another example includes selecting the KPI 302 in response to a current context of the service owner 104 (e.g., a support webpage the service owner 104 is reviewing, what events the service owner 104 is working on).

The recommendation system 106 calculates an ROI 304a to 304n for each action included in the recommendations 28a to 28n. The ROIs 304 provide an estimated or predicted outcome to the workloads 10 if the actions included in the recommendations 28 are performed. In some implementations, the ROIs 304 also provide a cost of the recommendation and a risk of the recommendation. As such, the ROIs 304 provide a tuple of information for the recommendations 28 so that the user (e.g., service owner 104) is easily able to understand the predicted outcome in combination with the cost and/or risk of implementing the recommendation. For example, recommendation 1 (28a) has a corresponding ROI 304a. One example of the ROI 304 includes an estimation of a reduction of events 12 (FIG. 1) in a workload 10. Another example of the ROI 304 includes a single composite score of the estimated benefit of the recommendation 28 (e.g., an estimated summary status combining the estimated KPI 302 for the recommendation 28). Another example of the ROI 304 is an estimated benefit of a single estimated KPI 302 (e.g., an estimated reduction in an amount of time spent on calls) chosen in response to a context of the service owner 104.

In some implementations, the recommendation system 106 receives as input the contributing factors 202 (FIG. 2) defined by the taxonomy-based factors classification 200 (FIG. 2) and uses the composite metric to evaluate the ROI 304 for a particular action included in the recommendation 28.

The recommendation system 106 outputs a set of recommendations 34 with a ranked list of the recommendations 28a, 28b, 28c up to 28n (where n is a positive integer) with the estimated benefit (e.g., reduction in noisy alerts, reductions in events, improvement in on-call scheduling) of the recommendations 28a, 28b, 28c. In some implementations, the recommendations 28a, 28b, 28c are sorted by descending ROIs 304a, 304b, 304c for each of the recommendations 28a, 28b, 28c. For example, the recommendation 1 28a has the highest ROI 304a (e.g., the highest estimated benefit and lowest cost and risk) and the recommendation 3 28c has a lower ROI 304c (e.g., a lower estimated benefit and highest cost and risk) as compared to the ROI 304a of the recommendation 1 28a and the ROI 304b of the recommendation 2 28b.

As such, the recommendation system 106 estimates a predicted outcome to the workload 10 if different actions included in the recommendations 28 are implemented by the service owners (e.g., service owners 104).

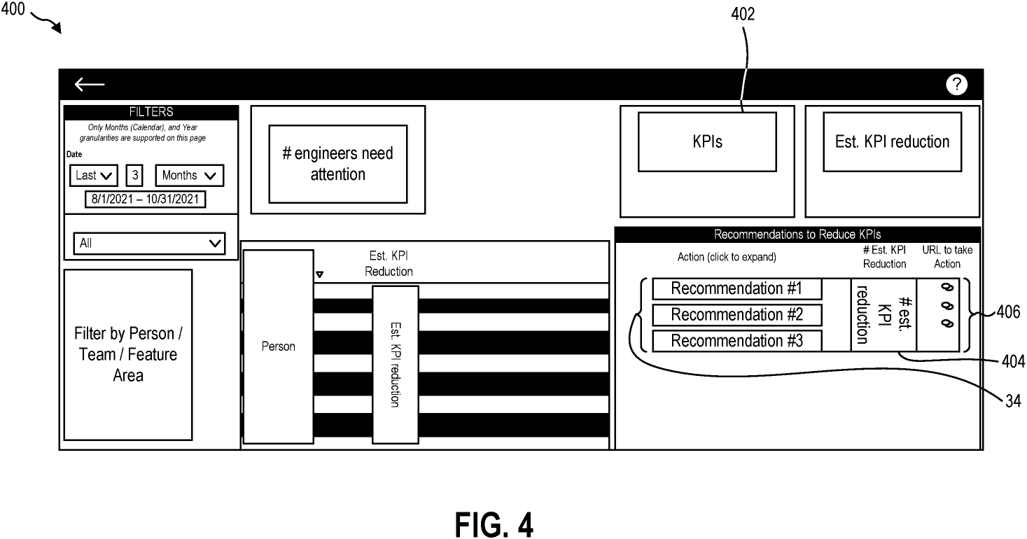

Referring now to FIG. 4, illustrated is an example GUI 400 of a dashboard presented to the service owners 104 (FIG. 1). For example, the dashboard is presented using the user interface 38 (FIG. 1) of the device 110 (FIG. 1). The dashboard provides information about a number of KPIs 402 identified for a service owner 104 and/or a team of service owners 104. The dashboard also provides a set of recommendations 34 to improve the number of KPIs 402 (e.g., reduce a number of KPIs). In some implementations, the set of recommendations 34 is output by the recommendation system 106 (FIG. 1).

The dashboard provides views of a specific impact 404 of each recommendation included in the set of recommendations 34. One example of the specific impact 404 of the recommendations includes an estimated reduction of KPIs 18 (FIG. 1). Another example of the specific impact 404 of the recommendations includes an estimated increase of KPIs 18. Another example of the specific impact 404 of each recommendation 28 includes identifying how many KPIs 18 would never have been created if the recommendation had been taken earlier by the service owner 104. The dashboard also includes links 406 the service owner 104 selects to implement the recommended action.

The dashboard provides a visual representation that allows the service owners 104 to easily review and understand the actions provided in the set of recommendations 34 and the corresponding estimated benefits of the different actions included in the set of recommendations 34. For example, the dashboard provides different graphs and charts illustrating the set of recommendations 34 and the corresponding estimated benefits of the different actions included in the set of recommendations 34.

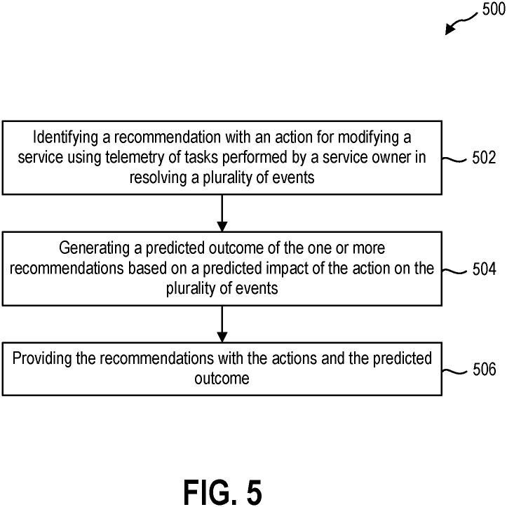

Referring now to FIG. 5, illustrated is an example method 500 for providing recommendations. The actions of the method 500 are discussed below with reference to the architectures of FIGS. 1-3.

At 502, the method 500 includes identifying a recommendation with an action for modifying a service using telemetry of tasks performed by a service owner in resolving a plurality of events. Resolving the plurality of events includes mitigating the events. The recommendation system 106 receives the telemetry 16 of the tasks 14 performed by the service owners 104 in resolving a plurality of events 12 (e.g., tasks performed by the service owner in resolving the events 12 in the workload 10, system parameters, and/or different contributing factors to the productivity of the service owner). In some implementations, the telemetry 16 is received from one or more datastores 108. In some implementations, the telemetry 16 is received from the service owners 104.

In some implementations, the plurality of events 12 are included in a workload 10 of the service owners 104. In some implementations, the plurality of events 12 are automatically created. The recommendation system 106 may monitor a performance of the service or the system 102 and compare the performance of the service or the system 102 to a metric. The recommendation system 106 may automatically create an event 12 in response to the performance of the service or the system 102 being below the metric.

In some implementations, the telemetry 16 includes the KPI 18 of factors contributing to the service. In some implementations, the telemetry 16 includes the KPI 18 of factors contributing to the workloads 10. Examples of the KPI 18 include a number of events included in the workloads, an amount of time required to resolve the events, a time of day when the events occurred, or a complexity of the events. In some implementations, the tasks 14 are performed on different systems 102 to resolve the events 12 and the telemetry 16 includes system information or system metadata of the different systems 102.

The recommendation system 106 uses the telemetry to identify one or more recommendations 28 with actions for modifying the service. In some implementations, the actions result in modifying the workloads 10 of the service owners 104. In some implementations, the recommendations 28 are changes to the systems 102. In some implementations, the recommendations 28 changes in the tasks 14 selected for resolving the events 12.

In some implementations, the recommendation system 106 includes one or more machine learning models 26 that analyze the workloads 10 of the service owners 104 and/or the telemetry 16 (e.g., the KPI 18 of factors contributing to the workloads 10 and/or the system information or system metadata of the different systems 102). The machine learning models 26 identify different recommendations 28 with one or more actions to take for modifying the service, the systems 102, and/or the workloads 10 of the service owners 104.

In some implementations, the one or more actions are tactical actions that handle live events of the service or the systems 102. In some implementations, the one or more actions are strategic actions that make offline changes to the service, the systems 102 and/or the workloads 10. Example actions include changes to the systems 102, changes to tasks 14 performed for resolving the events 12, and/or changes of an order of performing tasks 14 for resolving the events 12. In some implementations, the one or more actions leverage other data sources (e.g., external events, changes to the system, capacity issues).

At 504, the method 500 includes generating a predicted outcome of the one or more recommendations based on a predicted impact of the action on the plurality of events. The recommendation system 106 generates the predicted outcome of the one or more recommendations 28 based on a predicted impact of the action on the plurality of events. The predicted impact includes results of applying the action to the event(s) 12 (e.g., benefits of applying the action to the event(s) 12 or disadvantages of applying the action to the event(s) 12). In some implementations, the predicted outcome quantifies an improvement to the service. In some implementations, the predicted outcome quantifies an improvement to the systems 102. In some implementations, the predicted outcome quantifies an improvement to the workload. One example of improving the workload 10 includes reducing a number of events 12 in the workloads 10. In some implementations, improvement to the workload 10 is minimal, or there is no improvement if the recommendation 28 is implemented and the recommendations 28 indicates that the predicted outcome is zero or close to zero.

In some implementations, the predicted outcome 32 is presented as a ROI that quantifies a risk and/or cost of the predicted outcome as compared to a benefit of the service, the system 102, and/or the workloads 10. The recommendation system 106 analyzes the potential changes provided in the recommendations 28, risk to customer impact, and/or the predicted benefits (e.g., benefits to the on call service owner 104 or service) and tunes the recommendations 28 to optimize the ROI of the potential changes. In some implementations, the ROIs are tuned to minimize customer impact. In other implementations, the ROIs are tuned to maximize benefit to the service. In other implementations, the ROIs are tuned to maximize benefit to the service owner 104. As such, the ROI provides a tuple of information for the recommendation 28 including the predicted benefit, the cost, and the risk.

In some implementations, the predicted impact is based on a simulation of the action on the plurality of events 12. For example, one or more machine learning models 26 generate the predicted outcome of the one or more recommendations 28 in response to a simulation of an impact the actions on the plurality of events 12 included in the workloads 10 of the service owners 104. The one or more machine learning models 26 estimate one or more KPI (e.g., KPI 302) of the actions if the actions were applied to the workload 10 and the machine learning models 26 use the estimated one or more KPI to determine the predicted outcome.

In some implementations, the predicted outcome is determined by the machine learning models 26 by aggregating the one or more estimated KPI 18. In some implementations, the predicted outcome is determined by selecting one KPI of the estimated one or more KPI 18 in response to a context of the service owner 104. Examples of the context of the service owner 104 include a user profile of the service owner 104, a service that the service owner 104 supports, a service dependency graph, a support webpage the service owner 104 is viewing, and/or what events 12 the service owner 104 is working on.

At 506, the method 500 includes providing the recommendations with the actions and the predicted outcome. The recommendation system 106 provides a set of recommendations 34 with one or more recommendations 28. In some implementations, the set of recommendations 34 is presented in a ranked list based on the predicted outcome 32 of the recommendations 28. In some implementations, the set of recommendations 34 is presented in a descending order or an ascending order of ROI for the predicted outcomes. In some implementations, the recommendation system 106 provides the set of recommendations 34 for presentation on a user interface 38 of a device 110. In some implementations, the service owners 104 access the user interface 38 through a dashboard or webpage using the device 110. In some implementations, the user interface 38 is an interactive query interface.

The set of recommendations 34 are presented to the service owners 104 of the environment 100 as different actions or changes to implement to improve the workloads 10 of the service owners 104. The set of recommendations 34 also provide the estimated benefit (e.g., reliability of the service, availability of the service, reduction in noisy phone calls, reductions in events, fairness improvement in on-call scheduling) of the recommendations 28. The set of recommendations 34 provide insights into pain points or problematic areas of the workloads 10 for the service owners 104. The insights are used to provide actions to improve the workloads 10 (e.g., reduce the number of events 12 included in the workloads 10) of the service owners 104.

The method 500 provides recommendations 28 to the service owners 104 on what actions to take to reduce the service owners’ workload 10 by analyzing the service owner’s workload, telemetry 16, and/or related metadata from services worked on by the service owners 104.

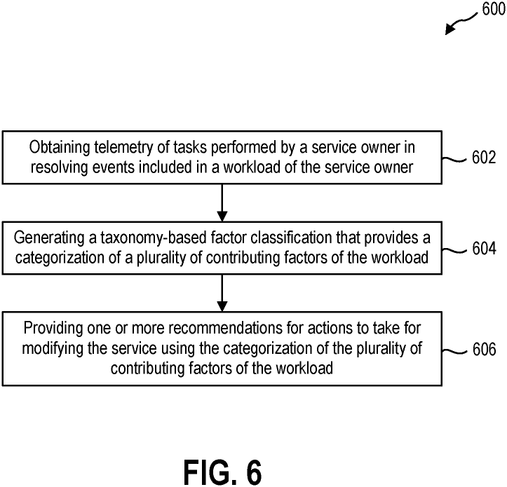

Referring now to FIG. 6, illustrated is an example method 600 for providing a taxonomy-based factor classification. The actions of the method 600 are discussed below with reference to the architectures of FIGS. 1-3.

At 602, the method 600 includes obtaining telemetry of tasks performed by a service owner in resolving events included in a workload of the service owner. In some implementations, the telemetry 16 information and/or the associated KPI 18 for different service owners 104 is obtained from one or more datastores 108. In some implementations, the telemetry 16 is obtained from the service owner 104 (e.g., in responding to questions and/or providing feedback). As such, the telemetry 16 includes qualitative information provided from the service owners 104 and quantitative information provided by the systems 102. In some implementations, the telemetry 16 is obtained of tasks performed by a plurality of service owners 104 in resolving events 12 included in the workloads 10 of the plurality of service owners 104.

At 604, the method 600 includes generating a taxonomy-based factor classification that provides a categorization of a plurality of contributing factors of the workload. The taxonomy-based factors classification 200 is generated using an aggregation of the telemetry 16 received for the different tasks 14 performed by the service owner 104 in resolving and/or troubleshooting the events 12 included in the workload 10. In some implementations, the taxonomy-based factors classification 200 is generated using an aggregation of the telemetry 16 received for the different tasks 14 performed by a plurality of service owners 104 in resolving the events 12 included in their workloads 10.

The taxonomy-based factor classification 200 provides a categorization of the of contributing factors 202 (e.g., the KPI 18) impacting on-call productivity of the service owners 104. One example of impacting a productivity of the service owners 104 includes increasing a response time for responding to the events in the workload. Another example of impacting a productivity of the service owners 104 includes increasing an amount of time to resolve the events in the workload. In some implementations, the taxonomy-based factor classification 200 provides a hierarchy of categories and sub-categories of the plurality of contributing factors 202.

In some implementations, a summary function, such as, a composite metric that provides a quantitative measure of the plurality of contributing factors 202 that impact a productivity of the service owners 104 is generated. The composite metric condenses the taxonomy-based factor classification 200 into a quantitative measure. The composite metric is an aggregate of the different categories and subcategories that impact the workloads 10 of the service owners 104 into a single score that is used to provide a standard metric for different evaluations. In some implementations, the composite metric is used as a standard metric to compare the quality of service of the workloads 10 across an organization. In some implementations, the composite metric is used as a standard metric to compare the workloads 10 among service owners 104 supporting the same systems 102 (FIG. 1), service, and/or product.

At 606, the method 600 includes providing one or more recommendations for actions to take for modifying the service using the categorization of the plurality of contributing factors of the workload. Modifications to the service or dependent services include modifications to monitoring or modification to incident managements. Another example of modifications to the service or dependent services includes a change in duration and/or order of on-call schedules. Another example of modifications to the services or dependent services includes enabling automation and intelligence based services to first handle the events 12 automatically (e.g., to auto close the events 12, transfer the events 12 to right team, upgrade or downgrade a severity of the events 12, collect relevant logs for debugging, auto run diagnostic tests) and then informing the service owners 104 that the events 12 needs their attention (after all the previous steps had been executed automatically, but without resolving the issue). In some implementations, the recommendation system 106 uses the categorization of the plurality of contributing factors 202 in identifying one or more contributing factors 202 that impact a productivity of the service owners 104. The recommendation system 106 provides one or more recommendations 28 with actions to change or modify the one or more contributing factors 202 to improve the service workloads 10 of the service owners 104. By improving the service, the workloads 10 of the service owners 104 may also improve (e.g., receiving less notifications of events 12 associated with the service)

In some implementations, modifying the workloads 10 include reducing a number of events 12 included in the workloads 10. In some implementations, the recommendations 28 are changes to the systems 102. In some implementations, the recommendations 28 changes in the tasks 14 selected for resolving the events 12.

The method 600 provides a taxonomy-based factor classification 200 that provides a mechanism to identify the different contributing factors 202 of on-call productivity by measuring the workloads 10 of the service owners 104 and enables new tasks 14 to be easily mapped to a global taxonomy view.

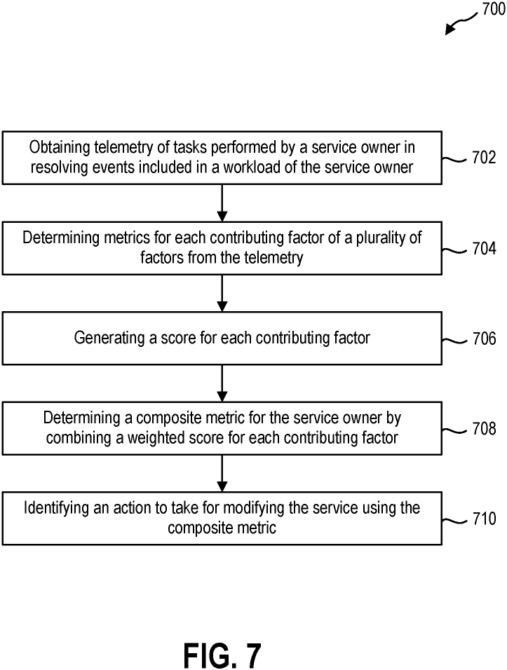

Referring now to FIG. 7, illustrated is a method for generating a composite metric for a plurality of contributing factors 202 (FIG. 2). The actions of the method 700 are discussed below with reference to the architectures of FIGS. 1-3.

At 702, the method 700 includes obtaining telemetry of tasks performed by a service owner in resolving events included in a workload of the service owner. The recommendation system 106 obtains the telemetry 16 of tasks performed by one or more service owners 104 in resolving events 12 included in the workloads 10 of the service owners 104. In some implementations, the telemetry 16 information and/or the associated KPI 18 for different service owners 104 is obtained from one or more datastores 108. In some implementations, the telemetry 16 is obtained from the service owner 104 (e.g., in responding to questions and/or providing feedback). As such, the telemetry 16 includes qualitative information provided from the service owners 104 and quantitative information provided by the systems 102. In some implementations, the telemetry 16 is obtained from the systems 102 used in performing the tasks.

At 704, the method 700 includes determining metrics for each contributing factor of a plurality of factors from the telemetry. The recommendation system 106 determines metrics for each contributing factor of the plurality of factors 202. In some implementations, the plurality of factors 202 include an amount of time required to resolve the events, a time of day when the events occurred, an amount of collaboration required to resolve the events, an amount of time the service owner is on call, or an outage occurred in a system.

At 706, the method 700 includes generating a score for each contributing factor. Each of the raw values of the contributing factors is measured and evaluated from the telemetry 16. For example, for on-call duration, the raw value is the sum of the total hours scheduled on rotation. The raw values are rescaled to avoid skewing to ensure that each subfactor is weighted independently and the weights are as expected. The rescaling standardizes each metric to arrive at a score for each contributing factor. The weights for the contributing factors may change based on feedback received from the service owners 104. In addition, the weights indicate a complexity of the events 12 and may change based on the complexity of the events 12. Different weights are applied to different contributing factors based on an intensity of the different contributing factors.

At 708, the method 700 includes determining a composite metric for the service owner by combining a weighted score for each contributing factor. The recommendation system 106 determines a composite metric for the service owner 104 by combining a weighted score for each contributing factor. The composite metric identifies a complexity of the events 12 included in the workload 10 of the service owner 104. The composite metric also provides insights into one or more contributing factors 202 that are impacting a productivity of the service owner 104.

In some implementations, the composite metric is compared to a baseline that aggregates the composite metric of other service owners to provide context to the composite metric. The raw score for the composite metric is compared against a benchmark sample of a baseline group and transformed into a percentage, where a higher percentage reflects a better score relative to a lower percentage. For example, a composite metric in the 90^{th} percentile of the baseline group leads to a composite metric of 90%. The final percentage is provided as the composite metric and is used to identify a relative ranking for each service owner 104. By comparing the composite metric relative to the baseline population, context is provided to the composite metric (e.g., the composite metric is lower than the baseline population and is an unhealthy score where an intervention may be needed, or the composite metric is higher than the baseline population and is a healthy score). In addition, the composite metric may be aggregated for teams and/or organizations and used to identify a ranking for teams of service owners 104 (e.g., a team of service owners 104 supporting a service). As such, the composite metric produces a curve relative to the baseline group where new experiences may be mapped to the curve.

At 710, the method 700 includes identifying an action to take for modifying the service using the composite metric. The recommendation system 106 uses the composite metric to identify one or more actions to take for modifying the service. Modifications to the service or dependent services include modifications to monitoring or modification to incident managements. Another example of modifications to the service or dependent services includes a change in duration and/or order of on-call schedule. Another example of modifications to the services or dependent services includes enabling automation and intelligence based services to first handle the events 12 automatically (e.g., to auto close the events 12, transfer the events 12 to right team, upgrade or downgrade a severity of the events 12, collect relevant logs for debugging, auto run diagnostic tests) and then informing the service owners 104 that the events 12 needs their attention (after all the previous steps had been executed automatically, but without resolving the issue). In some implementations, by modifying the service, the workload 10 of the service owner 104 is also modified. Modifying the workload 10 includes reducing a number of events 12 included in the workload 10 or reducing an intensity of the events 12 included in the workload 10.

(A1) Some implementations include a method. The method includes identifying a recommendation with an action for modifying a service using telemetry of tasks performed by a service owner in resolving a plurality of events. The method includes generating a predicted outcome of the recommendation based on a predicted impact of the action on the plurality of events. The method includes providing the recommendation with the action and the predicted outcome.

(A2) In some implementations, the method of A1 includes presenting, on a user interface, a plurality of recommendations in a ranked list, the plurality of recommendations including the recommendation, wherein the ranked list is based on the predicted outcome for each recommendation in the plurality of recommendations.

(A3) In some implementations of the method of A1 or A2, the plurality of events are included in a workload of the service owner.

(A4) In some implementations of the method of any of A1-A3, the action results in a reduction of the workload of the service owner.

(A5) In some implementations of the method of any of A1-A4, the action include tactical actions that handle live events.

(A6) In some implementations of the method of any of A1-A5, the predicted outcome is a return on investment (ROI) that quantifies a risk of the action and a cost of the action as compared to a benefit of the action.

(A7) In some implementations of the method of any of A1-A6, the action include strategic actions that make changes to systems, a plurality of events, or the workload.

(A8) In some implementations of the method of any of A1-A7, the predicted outcome is a return on investment (ROI) that quantifies a risk of the action and a cost of the action as compared to a benefit of the action.

(A9) In some implementations, the method of any of A1-A8 includes monitoring a performance of the service; comparing the performance of the service to a metric; and automatically creating an event in response to the performance of the service being below the metric.

(A10) In some implementations of the method of any of A1-A9, the predicted outcome is a return on investment (ROI) that quantifies a risk of the action and a cost of the action as compared to a benefit of the system.

(A11) In some implementations of the method of any of A1-A10, the predicted impact is based on a simulation of the action on the plurality of events.

(A12) In some implementations of the method of any of A1-A11, generating the predicted outcome includes estimating an impact of a key performance indicator of the action if the action was applied to the plurality of events; and using the impact of the key performance indicator to determine the predicted outcome.

(A13) In some implementations of the method of any of A1-A12, the telemetry includes KPI of factors contributing to the plurality of events.

(A14) In some implementations of the method of any of A1-A13, the KPI include an event included in the workload, an amount of time required to resolve the events, a time of day when the events occurred, or a complexity of the events.

(A15) In some implementations of the method of any of A1-A14, generating the predicted outcome comprises generating the predicted impact of the action by simulating the action on the plurality of events using a machine learning model.

(A16) In some implementations of the method of any of A1-A15, modifying the service includes a modification to monitoring of the service or a change in duration of on-call schedules for the service owner.

(A17) In some implementations, the method of any of A1-16 includes generating the predicted outcome of the recommendation based on prior workloads or artificial setups of the actions on the plurality of events.

(B1) Some implementations include a method. The method includes obtaining telemetry of tasks performed by a service owner in resolving events included in a workload of the service owner. The method includes generating a taxonomy-based factor classification that provides a categorization of a plurality of contributing factors of the workload. The method includes identifying an action to take for modifying the service using the categorization of the plurality of contributing factors of the workload.

(B2) In some implementations of the method of B1, modifying the service includes modifying monitoring of the service or modifying incident management of the service.

(B3) In some implementations, the method of B1 or B2 includes modifying the workload by reducing a number of events included in the workload or reducing an intensity of the events included in the workload.

(B4) In some implementations, the method of B1-B3, the action includes tactical actions that handle live events or strategic actions that make offline changes to systems or the workload.

(B5) In some implementations of the method of any of B1-B4, the plurality of contributing factors impact a productivity of the service owners by increasing a response time for responding to the events in the workload or increasing an amount of time to resolve the events in the workload.

(B6) In some implementations of the method of any of B1-B5, the taxonomy-based factor classification provides a hierarchy of categories and subcategories of the plurality of contributing factors.

(B7) In some implementations of the method of any of B1-B6, the taxonomy-based factor classification provides a global view of the plurality of contributing factors.

(B8) In some implementations, the method of any of B1-B7 includes determining a summary function of the workloads using the categorization of the plurality of contributing factors of the workloads; and identifying the action to take for modifying the workloads in response to the summary function exceeding a threshold level.

(B9) In some implementations of the method of any of B1-B8, the summary function is determined over different time periods and the summary function is used to identify changes in the workload over the time periods.

(B10) In some implementations of the method of any of B1-B9, the summary function provides an indication of a complexity of the events included in the workload.

(B11) In some implementations of the method of any of B1-B10, the summary function provides insights into one or more contributing factors that are impacting a productivity of the service owners.

(B12) In some implementations of the method of any of B1-B11, the summary function provides a standard metric to compare the workloads of different service owners.

(B13) In some implementations of the method of any of B1-B12, the threshold level identifies the workloads that need attention.

(B14) In some implementations of the method of any of B1-B13, the telemetry includes qualitative information or quantitative information.

(C1) Some implementations include a method. The method includes obtaining telemetry of tasks performed by a service owner in resolving events included in a workload of the service owner. The method includes determining metrics for each contributing factor of a plurality of factors from the telemetry. The method includes generating a score for each contributing factor. The method includes determining a composite metric for the service owner by combining a weighted score for each contributing factor. The method includes identifying an action to take for modifying a service using the composite metric.

(C2) In some implementations of the method of C1, the plurality of factors include one or more of an amount of time required to resolve the events, a time of day when the events occurred, an amount of collaboration required to resolve the events, an amount of time the service owner is on call, or an outage occurred in a system.

(C3) In some implementations of the method of C1 or C2, the composite metric identifies a complexity of the events included in the workload.

(C4) In some implementations of the method of C1-C3, the composite metric provides insights into one or more contributing factors that are impacting a productivity of the service owners.

(C5) In some implementations, the method of C1-C4 includes comparing the composite metric to a baseline, wherein the baseline aggregates composite metrics for other service owners.

(C6) In some implementations of the method of C1-C5, different weights are applied to different factors based on an intensity of the different factors.

(C7) In some implementations, the method of C1-C6 includes modifying the workloads by reducing a number of events included in the workloads or reducing an intensity of the events included in the workloads.

(C8) In some implementations, the method of C1-C7 includes identifying actions to take for modifying a system using the composite metric.

Some implementations include a system. The system includes one or more processors; memory in electronic communication with the one or more processors; and instructions stored in the memory, the instructions being executable by the one or more processors to perform any of the methods described here (e.g., A1-A17, B1-B14, C1-C8).

Some implementations include a computer-readable storage medium storing instructions executable by one or more processors to perform any of the methods described here (e.g., A1-A17, B1-B14, C1-C8).

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a transformer model, a classification model, a regression model, a language model, an object detection model) that can be tuned (e.g., trained) based on training input to approximate unknown functions. For example, a machine learning model may refer to a neural network (e.g., a transformer neural network, a convolutional neural network (CNN), deep neural network (DNN), recurrent neural network (RNN)), supervised classification model, unsupervised models for auto correlation, time series forecasting models, natural language processing for entity recognition and intent extraction, or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, embodiments of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. Unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
identifying a recommendation with an action for modifying a service using telemetry of tasks performed by a service owner in resolving a plurality of events;
generating a predicted outcome of the recommendation based on a predicted impact of the action on the plurality of events; and
providing the recommendation with the action and the predicted outcome.

2. The method of claim 1, wherein providing the recommendation further includes:
presenting, on a user interface, a plurality of recommendations in a ranked list, the plurality of recommendations including the recommendation, wherein the ranked list is based on the predicted outcome for each recommendation in the plurality of recommendations.

3. The method of claim 1, wherein the action results in a reduction of the workload of the service owner.

4. The method of claim 1, wherein modifying the service includes a modification to monitoring of the service or a change in duration of on-call schedules for the service owner.

5. The method of claim 1, wherein the predicted outcome is a return on investment (ROI) that quantifies a risk of the action and a cost of the action as compared to a benefit of the action.

6. The method of claim 1, wherein the predicted impact is based on a simulation of the action on the plurality of events.

7. The method of claim 1, wherein generating the predicted outcome further includes:
estimating an impact of a key performance indicator of the action if the action was applied to the plurality of events; and
using the impact of the key performance indicator to determine the predicted outcome.

8. The method of claim 1, wherein the telemetry includes key performance indicators of factors contributing to the plurality of events.

9. The method of claim 8, wherein the key performance indicators include an amount of time required to resolve the plurality of events, a time of day when the plurality of events occurred, or a complexity of the plurality of events.

10. The method of claim 1, wherein generating the predicted outcome comprises generating the predicted impact of the action by simulating the action on the plurality of events using a machine learning model.

11. A system, comprising:
a processor;
memory in electronic communication with the processor; and
instructions stored in the memory, the instructions being executable by the processor to:
identify a recommendation with an action for modifying a service using telemetry of tasks performed by a service owner in resolving a plurality of events;
generate a predicted outcome of the recommendation based on a predicted impact of the action on the plurality of events; and
provide the recommendation with the action and the predicted outcome.

12. The system of claim 11, wherein the instructions are further executable by the processor to generate the predicted outcome by:
estimating an impact of a key performance indicator of the action if the action was applied to the plurality of events; and
using the impact of the key performance indicator to determine the predicted outcome.

13. The system of claim 12, wherein the key performance indicators include an amount of time required to resolve the plurality of events, a time of day when the plurality of events occurred, or a complexity of the plurality of events.

14. The system of claim 11, wherein the predicted outcome is a return on investment (ROI) that quantifies a risk of the action and a cost of the action as compared to a benefit of the action.

15. The system of claim 11, wherein the instructions are further executable by the processor to:
present, on a user interface, a plurality of recommendations in a ranked list, the plurality of recommendations including the recommendation, wherein the ranked list is based on the predicted outcome for each recommendation in the plurality of recommendations.

16. The system of claim 11, wherein the action results in a reduction of a workload of the service owner.

17. The system of claim 11, wherein modifying the service includes a modification to monitoring of the service or a change in duration of on-call schedules for the service owner.

18. The system of claim 11, wherein the predicted outcome is based on a simulation of the action on the plurality of events.

19. The system of claim 11, wherein generating the predicted outcome of the recommendation is based on prior workloads or artificial setups of the actions on the plurality of events.

20. The system of claim 11, wherein the telemetry includes key performance indicators of factors contributing to the plurality of events.
